(19) United States
(12) Patent Application Publication
(10) Pub. No.: US 2010/0031344 A1
(43) Pub. Date: Feb. 4, 2010

(54) TOUCH-SCREEN BASED PASSWORD INPUT SYSTEM AND ELECTRONIC DEVICE HAVING SAME

(75) Inventors: ER-ZHENG ZHAO, Shenzhen City (CN); HONG-WEI ZHU, Shenzhen City (CN); HAI-YANG YU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (TW); HON HAI PRECISION INDUSTRY CO., LTD., Tu-Cheng (TW)

(21) Appl. No.: 12/501,499

(22) Filed: Jul. 13, 2009

(30) Foreign Application Priority Data
Aug. 1, 2008 (CN) 200810303309.2

(51) Int. Cl. H04L 9/32; G06F 21/00; G06F 17/30

(52) U.S. Cl. 726/18; 345/173; 707/100; 707/E17.044

(57) ABSTRACT

An electronic device includes multi-touch screen and a password input system. The multi-touch screen can detect a sequence of user inputs, each of which involves tapping at least one point thereof. The password input system includes a determining unit, a storing unit, an indexing unit, and an outputting unit. The determining unit can count the numbers of touch point(s) of the user inputs. The storing unit stores a character database which includes a collection of numbers of touch point(s) and a collection of corresponding machine-readable characters. The indexing unit can look up matching machine-readable characters for the user inputs in the character database. The outputting unit can output the matching machine-readable characters sequentially as a password.

### BACKGROUND

1. Technical Field

The present disclosure relates to password input systems and, particularly, to a touch-screen based password input system and an electronic device having the same.

2. Description of Related Art

Generally, passwords, such as personal identification numbers (PINs), are inputted via a physical or virtual keyboard to gain access to resources. However, when inputting a password by the keyboard, users must take the extra precaution to look at the keyboard, find and press desired keys sequentially. This task is not convenient.

Therefore, it is desirable to provide a touch-screen based password input system and an electronic device having the same, which can overcome the above-mentioned problems.

### BRIEF DESCRIPTION OF THE DRAWINGS

FIG. 1 is a functional block diagram of an electronic device, according to an exemplary embodiment.

FIG. 2 is a schematic view showing a first user input operation on a multi-touch screen of the electronic device of FIG. 1.

FIG. 3 is a schematic view showing a second user input operation on the multi-touch screen of the electronic device of FIG. 1.

FIG. 4 is a schematic view showing a third user input operation on the multi-touch screen of the electronic device of FIG. 1.

### DETAILED DESCRIPTION

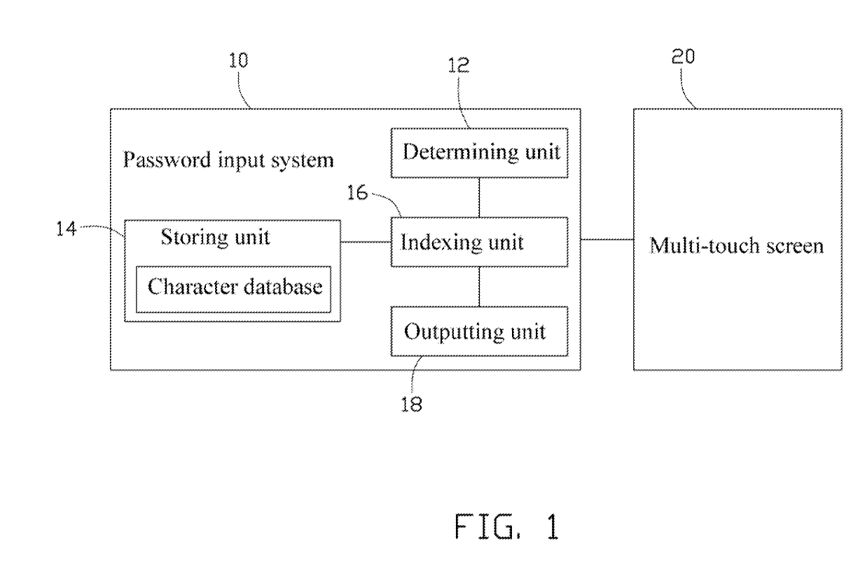

Referring to FIG. 1, an electronic device 100, according to an exemplary embodiment, includes a password input system 10 and a multi-touch screen 20. The electronic device 100 can be but is not limited to a mobile phone, a personal digital assistant, a gaming device, or a laptop computer.

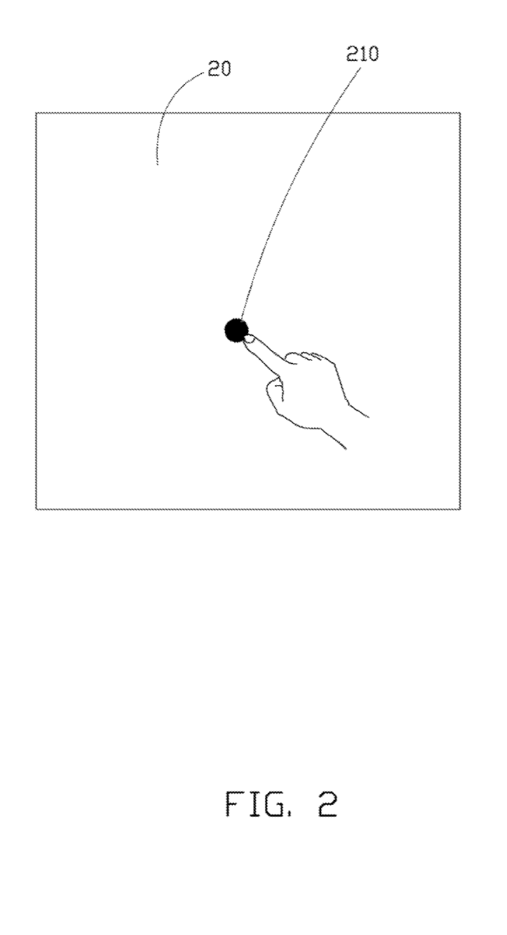

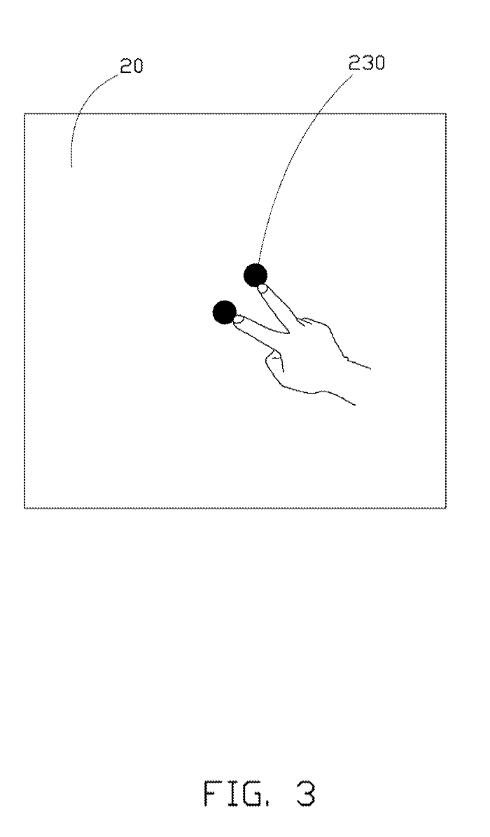

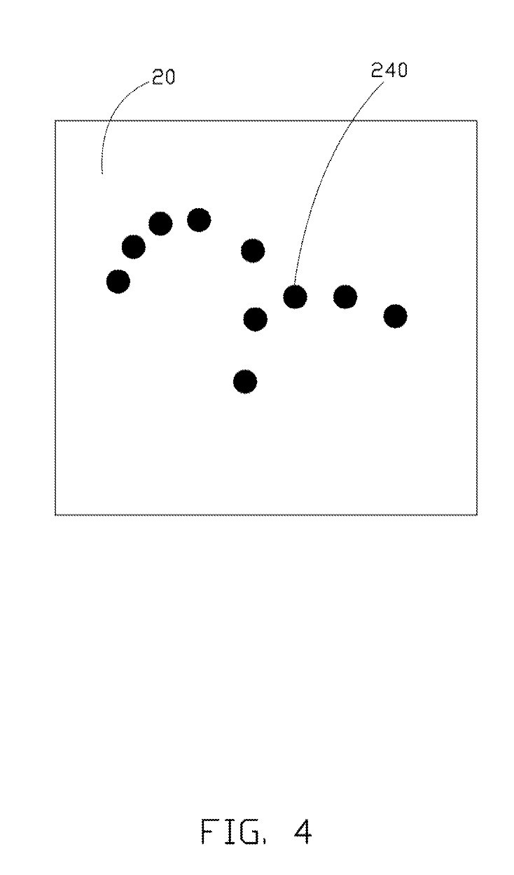

The multi-touch screen 20, such as a liquid crystal display (LCD) based touch panel, is configured for receiving and detecting user inputs, each of which involves tapping at least one point of the multi-touch screen 20 simultaneously. For example, the multi-touch screen 20 can detect a first user input 210 of tapping the multi-touch screen 20 with one finger, as shown in FIG. 2. Also, the multi-touch screen 20 can detect a second user input 230 of tapping the multi-touch screen 20 with two fingers, as shown in FIG. 3. The multi-touch screen 20 also can detect a third user input 240 of tapping the multi-touch screen 20 with ten fingers, as shown in FIG. 4 (fingers are not shown).

The password input system 10 is configured for interpreting a sequence of user inputs as a password and inputting the password to the electronic device 100 for authentication, to prove identity or gain access to resources of the electronic device 100. For example, in this embodiment, the password input system 10 can interpret a sequence of user inputs into a PIN. In detail, if the user inputs 210, 230, 240, as shown in FIGS. 2-4, are operated sequentially. The password input system 10 can interpret the user inputs 210, 230, 240 as a PIN, e.g., “120”. In detail, the password input system 10 includes a determining unit 12, a storing unit 14, an indexing unit 16, and an outputting unit 18.

The detecting unit 12 is configured for determining the numbers of touch point(s) of each of the sequence of user inputs. For example, the determining unit 12 can count the numbers of touch point(s) of the user inputs 210, 230, 240, as shown in FIGS. 2-4, as “1, 2, and 10”.

The storing unit 14 is configured for storing a character database which includes a collection of numbers of touch point(s) and a collection of machine-readable characters, where each machine-readable character is associated with a corresponding number of touch point(s). In this embodiment, all the machine-readable characters are numerals. To provide better understanding of the character database, an example is given below. However, the character database is not limited to this embodiment, but can be set and edited by manufacturers or users.

### Character Database

| Numbers of touch point(s) | Machine-readable characters |
|---|---|
| 1 | 1 |
| 2 | 2 |
| 3 | 3 |
| 4 | 4 |
| 5 | 5 |
| 6 | 6 |
| 7 | 7 |
| 8 | 8 |
| 9 | 9 |
| 10 | 0 |

The indexing unit 16 is configured for looking up matching machine-readable characters of the numbers of touch point(s) of the user inputs in the character database. For example, the indexing unit 16 looks up matching machine-readable characters for the user inputs 210, 230, 240, as shown in FIGS. 2-4, and yields the matching machine-readable characters “1”, “2”, and “0” to the outputting unit 18.

The outputting unit 18 is configured for outputting the matching machine-readable characters to the electronic device 100, e.g., a processor of the electronic device 100, sequentially, as a password. For example, the outputting unit 18 of this embodiment can output a PIN “120”.

When inputting a password using the password input system 10, users are free from the inconvenience of looking at a keypad to find the desired keys, therefore inputting passwords become easier, as compared to using keypads.

While various exemplary and preferred embodiments have been described, it is to be understood that the invention is not limited thereto. To the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. A password input system for an electronic device, the electronic device comprising a multi-touch screen, the multi-touch screen being configured for receiving and detecting a sequence of user inputs each of which involves tapping at least one point thereof, the password input system comprising:
a determining unit configured for determining the numbers of touch point(s) of the user inputs;
a storing unit storing a character database, the character database comprising a collection of numbers of touch point(s) and a collection of machine-readable characters, where each machine-readable character is associated with a corresponding number of touch point(s);
an indexing unit configured for looking up a plurality of matching machine-readable characters of the numbers of touch point(s) of the sequence of user inputs; and
an outputting unit configured for outputting the matching machine-readable characters sequentially as a password.

2. The password input system of claim 1, wherein the character database is:

| Numbers of touch point(s) | Machine-readable characters |
|---|---|
| 1 | 1 |
| 2 | 2 |
| 3 | 3 |
| 4 | 4 |
| 5 | 5 |
| 6 | 6 |
| 7 | 7 |
| 8 | 8 |
| 9 | 9 |
| 10 | 0 |

3. An electronic device comprising:
a multi-touch screen configured for receiving and detecting a sequence of user inputs each of which involves tapping at least one point thereof; and
a password input system comprising:
a determining unit configured for determining the numbers of touch point(s) of the user inputs;
a storing unit storing a character database, the character database comprising a collection of numbers of touch point(s) and a collection of machine-readable characters, where each machine-readable character is associated with a corresponding number of touch point(s);
an indexing unit configured for looking up a plurality of matching machine-readable characters of the numbers of touch point(s) of the sequence of user inputs; and
an outputting unit configured for outputting the matching machine-readable characters sequentially as a password.

4. The electronic device of claim 3, wherein the character database is:

| Numbers of touch point(s) | Machine-readable characters |
|---|---|
| 1 | 1 |
| 2 | 2 |
| 3 | 3 |
| 4 | 4 |
| 5 | 5 |
| 6 | 6 |
| 7 | 7 |
| 8 | 8 |
| 9 | 9 |
| 10 | 0 |

5. The electronic device of claim 3, wherein the touch screen is liquid crystal display based.

6. The electronic device of claim 3, being selected from the group consisting of a mobile phone, a personal digital assistant, a gaming device, or a laptop computer.
